(19) United States
(12) Patent Application Publication
(10) Pub. No.: US 2016/0276052 A1
(43) Pub. Date: Sep. 22, 2016

(54) Self-Assembly of Nanotubes

(71) Applicant: IMPERIAL INNOVATIONS LIMITED, London (GB)

(72) Inventors: Milo Sebastian Peter Shaffer, London (GB); Joachim Steinke, London (GB)

(21) Appl. No.: 15/033,410

(22) PCT Filed: Nov. 4, 2014
(86) PCT No.: PCT/EP2014/073741

§ 371 Date: Apr. 29, 2016

(30) Foreign Application Priority Data
Nov. 4, 2013 (GB) 1319445.1

(51) Int. Cl. H01B 1/12; B05D 1/18

(52) U.S. Cl. CPC H01B 1/12; B05D 1/18; B82Y 40/00

(57) ABSTRACT

The present invention relates to a nanostructure comprising a first hollow nanotube having at least one open end and a first anchor structure comprising a first anchor portion configured to anchor within the open end of the first nanotube, the first anchor structure further comprising a tether portion arranged to allow at least a part of said tether portion to extend outside of the end of the nanotube.

### TECHNICAL FIELD

The present invention generally relates to the field of nanomaterials.

### BACKGROUND

Single walled carbon nanotubes (SWNTs) have shown excellent potential in electronic, mechanical, and other functional applications. Semiconducting SWNTs are of particular relevance in the field of nano-electronics, for example in the form of thin film transistors (TFTs) and molecule sensors; networks of metallic tubes are widely considered as transparent conducting films (TCFs) for displays, touch screens, and solar cells.

However, to date, application of SWNTs has been limited by the heterogeneity of the SWNTs produced in synthesis processes and difficulties with their integration. Recent post-synthetic strategies for purification and length/diameter/electronic type separation of SWNTs have significantly improved the quality of resulting SWNTs.

Selective self assembly of sorted SWNTs, however, is needed to prepare well defined networks for specific applications, for example as TFTs, TCFs, or 3d gas sorbents, in which connectivity and junctions/contacts determine performance. At present only random or roughly aligned networks have been prepared. Attempts to use chemistry to direct assembly have been limited by the variety and number of reactive sites on any given nanotube. Methods to connect or join specific SWNTs are similarly absent. Individual SWNTs offer exceptional performance in a variety of contexts; for example, single SWNT FETs have the best performance of any room temperature transistor, and fortuitous one-off junctions between SWNTs of different types have been shown to have excellent device characteristics. However, a rational strategy for creating specific junctions, or integrating multiple SWNTs devices is absent. The assembly of SWNTs and other nanostructures onto other supports or electrodes also remains challenging.

Purification of carbon nanotubes often generates carboxylic acid groups at the open ends of the nanotubes. However, given the number of carbon atoms (and thus carboxylic acids groups) at the ends of the nanotubes, and usually the presence of further carboxylic acid groups on the outer walls of the nanotubes, attempts to use conventional chemistry to join the ends of two nanotubes together leads to uncontrolled and undesirable side reactions.

It is therefore desirable to be able to easily manipulate the open ends of nanotubes, for example to be able to join, or link, the open ends of nanotubes without undesirable side reactions and in a controlled manner.

Nanotubes have been used to encapsulate fullerenes such as C₆₀ (Berber et al, Phys Rev Lett, 2002, 88, p 18) and C₇₀ (Maniwa et al, J. Phys. Soc. Jpn., 2003, 72, 1, p 45). Boron nitride nanotubes have been used to encapsulate fullerenes such as C₆₀ (Mickelson et al, Science, 2003, 300, p 467) and boron nitride clusters (Oku et al, 2004, Mater. Manuf. Process, 2004, 19, p 1215). These structures are known as “peapods”. Furthermore, nanotubes have been postulated as drug-delivery devices (Chapter 16, Smart Materials for Drug Delivery, RSC Publishing 2013, Carmen Alvarez-Lorenzo, Angel Concheiro). In particular, nanotubes having one open end have been filled with an active ingredient, and then “stoppered” using a fullerene. When the nanotube is in situ, the fullerene can be caused to exit the nanotube, thereby allowing the release of the active ingredient from the nanotube.

### SUMMARY OF THE INVENTION

In a first aspect, the present invention relates to a nanostructure comprising a first hollow nanotube having at least one open end and a first anchor structure comprising a first anchor portion configured to anchor within the open end of the first nanotube, the first anchor structure further comprising a tether portion arranged to allow at least a part of said tether portion to extend outside of the end of the nanotube.

In a second aspect, the present invention therefore provides for a method for attaching a nanotube to a support, the method comprising the steps of:
a. Providing a solution comprising a first nanotube having at least one open end,
b. Providing a first anchor structure comprising a first anchor portion and a tether portion, wherein the first anchor portion of the first anchor structure is configured to anchor within the open end of the nanotube and the tether portion is arranged to allow at least a part of said tether portion to extend outside of the end of the nanotube,
c. Exposing the solution of step a) to the first anchor structure of step b); and
d. Attaching the tether portion to a support.

In a third aspect, the present invention provides a process for thermally annealing a nanostructure according to the first aspect, the method comprising the step of heating a nanostructure according to the first aspect, optionally under a vacuum.

In a fourth aspect, the present invention relates to a continuous nanotube structure obtained by the method according to the third aspect.

In a fifth aspect, the present invention relates to a device comprising a nanostructure according to the first aspect or a continuous nanotube structure according to the fourth aspect. In preferred embodiments, the device is an electronic device.

### BRIEF DESCRIPTION OF FIGURES

FIGS. 1 to 3: Schematic representation of various nanostructure assemblies according to the present invention.

FIG. 4: Method for preparing continuous nanotube structures according to the invention.

FIG. 5: Schematic representation of a nanostructure of the invention.

FIG. 6: Schematic representation of nanostructures comprising nanotubes having different electronic properties. The structures may be useful in various nano-electronic applications.

FIG. 7: Illustration of selective diameter dependent separation of nanotubes.

FIGS. 8 to 10: Schematic representation of various nanostructure assemblies according to the present invention.

FIGS. 11 and 12: AFM image of nanostructures comprising HiPco SWNT and bis-fullerene end-capped flexible linker (PEG₂₀₀PCBM₂).

FIG. 13: Schematic illustration of nanotube assembly on a surface.

FIG. 14: AFM height images of (a) self assembled carbon SWNT network on C₆₀-MSW5 (b) Histogram of diameter distribution of self assembled carbon SWNT network on C₆₀-MSW5 (˜110 SWNTs identified from a). (c) individualized carbon SWNTs on MSWs (Control 1: assembly experiment with MSW) (d) Height analysis of three selected cross-sections in c.

FIG. 15: Histograms of diameter distribution of the adsorbed (top) and non-adsorbed (bottom) carbon SWNTs on the basis of AFM observations. Grey line across the curve represents f-width.

FIG. 16: AFM of arc-discharged SWNTs with 3BPCBM.

FIG. 17: Schematic representation of a nanotube encapsulating an anchor portion (e.g. a carbon or boron nitride fullerene). Figure B shows the “space-filled” version of Figure A.

### DISCLOSURE OF THE INVENTION

The present invention is defined in the accompanying claims.

In a first aspect, the present invention relates to a nanostructure which is formed by the self assembly of a first nanotube with a first anchor structure.

The present invention is based on the recognition that single walled carbon or boron nitride nanotubes are capable of encapsulating carbon or boron nitride fullerenes (e.g. buckyballs, such as C₆₀), and that the interactions between the nanotube and the fullerene (e.g. buckyball) may allow for the manipulation of the end of the carbon or boron nitride nanotube and thus the formation of higher, complex structures and assemblies of nanotubes. In particular, a carbon or boron nitride fullerene (e.g. a C₆₀ molecule) can fit within a nanotube (i.e. a single walled carbon or boron nitride nanotube) if the smallest inner van der Waals diameter of the nanotube is the same as, or slightly larger than, the largest outer van der Waals diameter of the fullerene (e.g. C₆₀). The van der Waals interactions between the fullerene (e.g. C₆₀ molecule) and the nanotube results in the “anchoring” (i.e. adsorption) of the fullerene (e.g. C₆₀) to the inner wall of the nanotube.

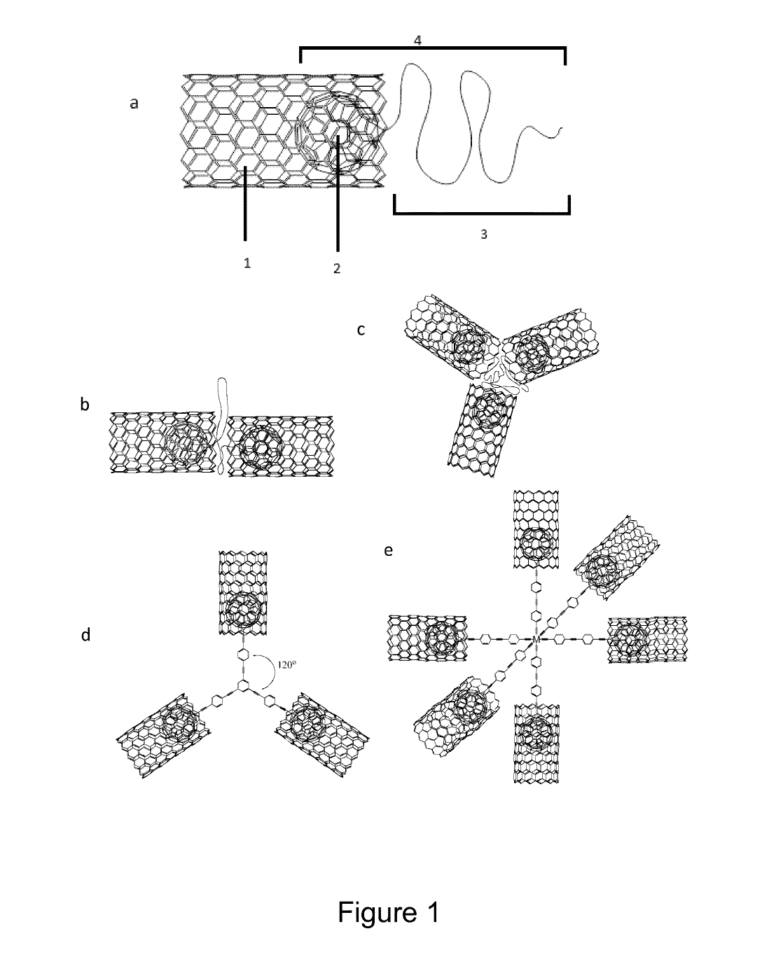

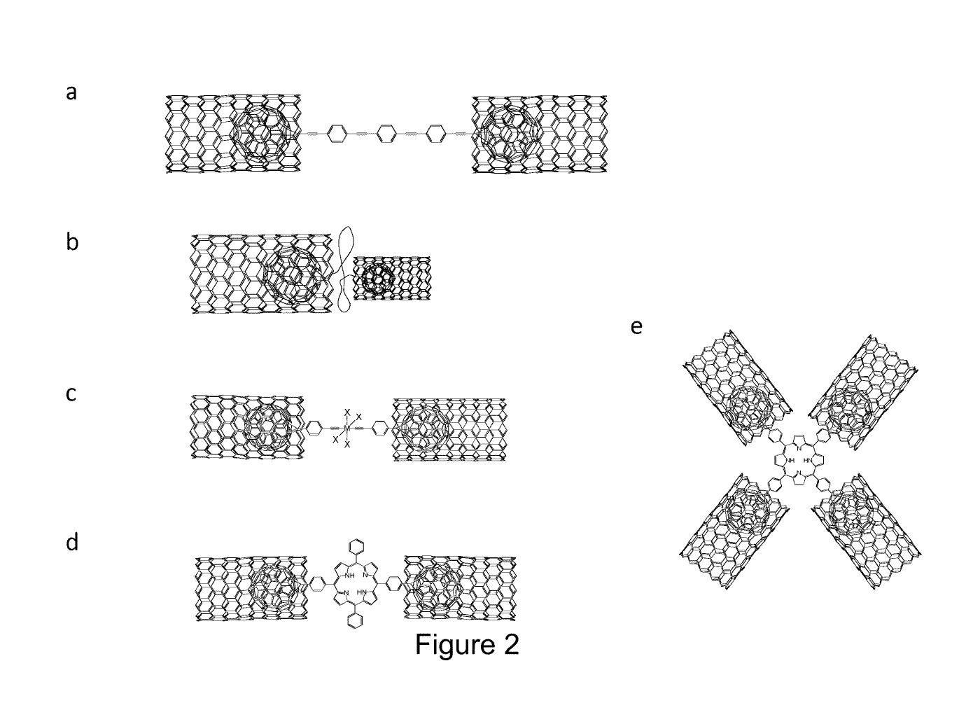

Fullerenes (e.g. C₆₀) can be attached covalently to a wide range of different moieties, such as polymers, organic and organometallic compounds, and macrocycles. These moieties are referred to herein as “tether portions”. The tether portion should allow the fullerene (e.g. C₆₀) to fit entirely or at least in part within the end of the nanotube, whilst itself extending (at least in part) outside of the end of the nanotube. This may be achieved by having a tether portion whose steric bulk prevents the entire tether portion from fitting within the end of the nanotube. For example, as shown in FIG. 1 a-c, the tether portion may comprise a polymer which, when in solution, can adopt a random coil formation, thereby ensuring at least a part of the polymer is outside of the end of the nanotube. Alternatively, as shown in FIG. 1 d-e and FIG. 2 d-e, the tether portion may comprise an organic or an organometallic moiety whose geometry allows at least a part of the tether portion to remain outside of the end of the nanotube.

If a fullerene (e.g. C₆₀) is attached to a tether portion, when the fullerene (e.g. C₆₀) fits within the end of a nanotube, at least a part of the tether portion can extend outside of the nanotube, thereby allowing for the functionalization of the end of the nanotube.

For example, the tether portion may be attached to a second fullerene (e.g. a second C₆₀ molecule). The second fullerene (e.g. C₆₀ molecule) can fit within the open end of a second nanotube (preferably a SWCNT or SWBNNT) whose smallest inner van der Waals diameter is substantially similar to the largest van der Waals diameter of the second fullerene (e.g. C₆₀ molecule). This will result in a complex where the first and second nanotubes are anchored to a single moiety, or “anchor structure” which comprises two fullerenes (e.g. two C₆₀ molecules) and a tether portion.

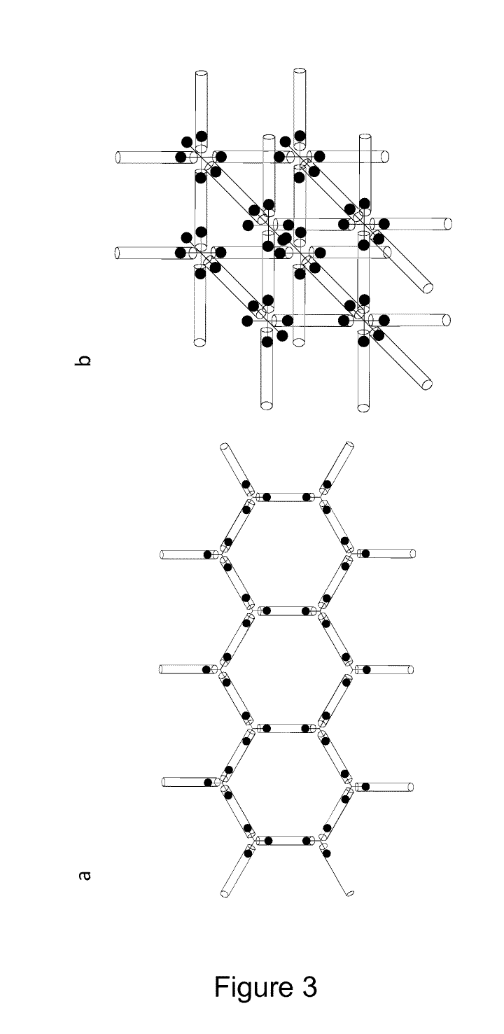

If both ends of the first nanotube are open, it will be appreciated that each end can accommodate a fullerene (e.g. a C₆₀ molecule) attached to a tether portion. Furthermore, if both tether portions are attached to a second fullerene (e.g. a second C₆₀ molecule), both of these second fullerenes (e.g. both C₆₀ molecules) can anchor a further nanotube. If both ends of the further nanotubes are open, they can accommodate further fullerene(s) (e.g. further C₆₀ molecule(s)). The skilled person will understand that this allows for the formation of continuous supramolecularly linked networks of SWCNTs and/or SWBNNTs, examples of which are shown in FIG. 3.

It will be understood that the principle explained above can be applied to other nanotubes and other anchor structures.

Therefore in a first aspect of the invention, there is provided a nanostructure comprising a first hollow nanotube (1) having at least one open end and a first anchor structure (4) comprising a first anchor portion (2) configured to anchor within the open end of the first nanotube (1), the first anchor structure (4) further comprising a tether portion (3) arranged to allow at least a part of said tether portion to extend outside of the end of the nanotube.

The skilled person will appreciate that, in order for the first anchor portion to be capable of anchoring the nanotube, the first anchor portion must be able to fit within the open end of the nanotube. Therefore, the smallest inner van der Waals diameter of the nanotube may be the same as, or greater than, the largest outer van der Waals diameter of the first anchor portion. In preferred embodiments of the invention, the smallest inner van der Waals diameter of the nanotube is substantially similar to the largest outer van der Waals diameter of the first anchor portion.

The first anchor portion anchors to least a part of the inner surface of the nanotube. By “anchor” it is meant that the interactions between the anchor portion and the inner surface of the nanotube are sufficient to cause the anchor portion to remain within the open end of the nanotube. For example, the anchor portion may adsorb to the inner surface of the nanotube. In other words, the open end of the nanotube may endohedrally encapsulate the anchor portion.

By “substantially similar”, it is meant that the smallest inner van der Waals diameter of the nanotube is the same as, or slightly larger than (e.g. about 0.05 nm to about 0.3 nm greater than), the largest outer van der Waals diameter of the first anchor portion.

The diameters of the nanotubes and anchor portions are measured in terms of their van der Waals diameter. Usually the diameter of a nanotube (e.g. a carbon nanotube) is measured from the atom centres using Raman spectroscopy or microscopy to deduce the dimensions. This distance is referred to as the “normal”, or nucleus-to-nucleus, nanotube diameter. The skilled person will appreciate that the inner van der Waals diameter can be determined by subtracting the van der Waals diameter of the nanotube atom (i.e. carbon for a carbon nanotube) from the normal nanotube diameter.

The largest van der Waals diameter or the anchor portion (i.e. a carbon or boron nitride fullerene, such as C₆₀) can be determined using x-ray crystallography.

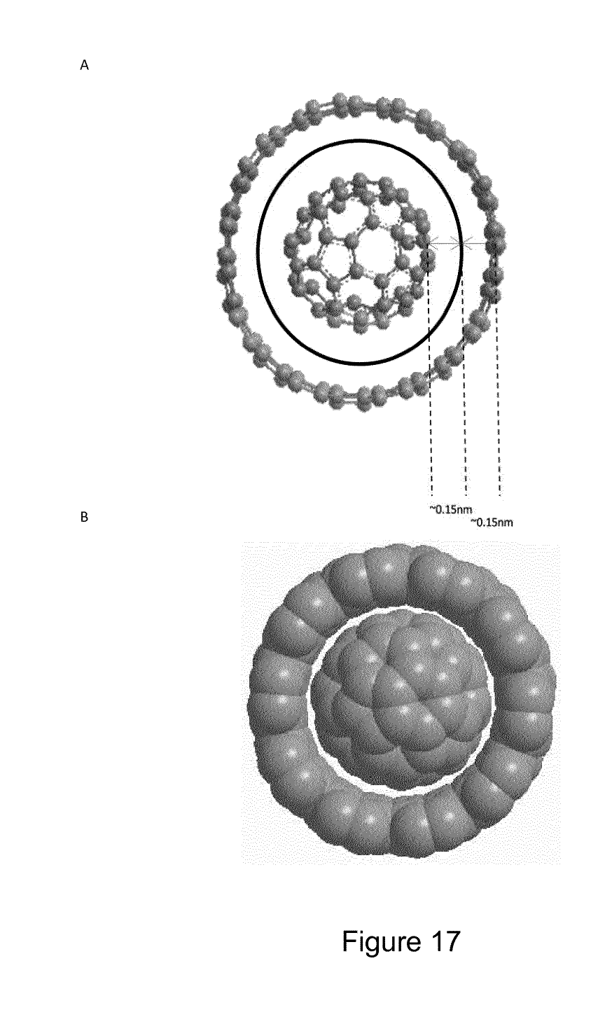

Therefore, once the skilled person has determined the largest van der Waals diameter of the anchor portion, the size of the smallest inner “normal” diameter of the nanotube can be determined by adding the van der Waals diameter of the nanotube atom (i.e. carbon for a carbon nanotube) to the largest van der Waals diameter of the anchor portion. In other words, as shown in FIG. 17, the skilled person will understand that the spacing between the nucleus of the atoms of the anchor portion and the nucleus of the atoms of the nanotube will be similar to the layer spacing in the analogous layered compound (e.g. graphite for carbon species. The corresponding hexagonal boron nitride species have about the same interlayer spacing as graphite; see Hod, J. Chem. Theory Comput., 2012, 8(4), 1360, the entire contents of which are hereby incorporated by reference).

The nanotube may be any type of nanotube, that is, it may be any hollow tubular structure having at least one dimension measuring on the nanometer scale. For example, the nanotube may have a smallest inner van der Waals diameter measuring between about 0.5 nm to about 20 nm, for example between about 0.7 nm to about 10 nm, e.g. between about 0.8 nm to about 10 nm. Preferably the smallest inner van der Waals diameter of the nanotube is around about 1 nm to about 2 nm.

The nanotube may be of any length. For example, the nanotube may have a length which is greater than about 0.5 nm, for example between about 2 nm to about 10000 nm, e.g. between about 5 nm to about 500 nm.

The nanotubes used in the first aspect may be made of any material which is capable of forming a nanotube. Such materials are well known to the person skilled in the art. For example, the nanotube may be a carbon nanotube, a boron-nitride nanotube, or a boron or nitrogen doped carbon nanotube. Alternatively, the nanotube may be an inorganic nanotube, such as a nanotube comprising a metal dichalcogenide. Examples of inorganic nanotubes include nanotubes comprising tungsten(IV) sulfide (WS₂), molybdenum disulfide (MoS₂), tin(IV) sulfide (SnS₂), titanium dioxide (TiO₂) or titanates, and zinc oxide (ZnO). However, the nanotubes are preferably single-walled carbon nanotubes, boron-nitride nanotubes, boron or nitrogen doped carbon nanotubes or combinations thereof. The skilled person will appreciate that the nanotube(s) used in the first aspect may be the same or different. In certain preferred embodiments, each of the nanotubes used in the nanostructure of the first aspect is a single-walled carbon nanotube (SWCNT) or each of the nanotubes used in the nanostructure of the first aspect is a single-walled boron nitride nanotube (SWBNNT). It will also be appreciated that the nanotubes used in the nanostructure of the first aspect may be a mixture of SWCNTs and SWBNNTs. It will be appreciated that the term carbon nanotube also encompasses boron or nitrogen doped carbon nanotubes.

The skilled person will appreciate that nanotubes, and in particular, carbon nanotubes may adopt a variety of structures. For example, the nanotube may have a single wall, i.e. it may be a single walled nanotube “SWNT”. The nanotube may also have more than one wall, i.e. it may be a multi-walled nanotube (MWNT), such as a double walled nanotube (DWNT) or a triple walled nanotube (TWNT). It will be appreciated that the invention can be applied to nanotubes having more than one wall (MWNTs), and in this instance, the anchor portion must have a largest outer van der Waals diameter which is the same as, or smaller than, the smallest inner van der Waals diameter of the inner-most tube of the multi-walled nanotube. In particularly preferred embodiments, the nanotube is a SWNT such as a SWCNT or a SWBNNT.

Single-wall carbon nanotubes (SWCNTs) are cylindrical tubes of carbon atoms that can assume a wide range of atomic structures. Each structure is defined by two positive integers (n, m) called the chiral indices. A SWCNT can be thought of as a single sheet of graphene rolled up into a seamless molecular cylinder. C is the chiral vector and indicates the direction of the rolling. C extends from one carbon atom to a crystallographically equivalent atom on the graphene lattice. Thus, C can be written as a linear combination of the lattice basis vectors:

C=n a₁+m a₂

Here, n and m are positive integers known as the chiral indices. All physical properties of a given SWCNT ultimately depend on these two numbers. SWCNTs of different atomic structure result for various choices of n and m. When m=n, the nanotube is known as an armchair nanotube. When m=0, the nanotube is referred to as a zigzag nanotube. For any other values of m and n, the nanotubes are referred to as chiral nanotubes.

Depending on their n, m values, carbon nanotubes can either be electrically metallic or semi-conducting. In general, an (m, n) SWCNT will be metallic when n −m=3q, wherein q is 0, 1, 2, 3, 4, 5 etc.

The skilled person will therefore appreciate that SWCNTs which have the same, or a very similar smallest inner diameter may have different conductive properties. For example, a SWCNT having an (m, n) of (6,3) is metallic, whereas a SWCNT having an (m, n) of (7,0) is a semi-conductor, however both have roughly the same smallest inner diameter. In a further example, a SWCNT having an (m, n) of (10, 10) is metallic, whereas a SWCNT having an (m, n) of (11, 9) is a semi-conductor, however the smallest inner “normal” diameter of both nanotubes is about 1.4 nm.

Carbon nanotubes can be thermally conductive. Furthermore, while boron nitride nanotubes have very similar structure and geometry to carbon nanotubes, they are electrically insulating.

The first nanotube has at least one open end. Preferably, both ends of the first nanotube are open. When the nanostructure of the first aspect comprises more than one nanotube, it is preferred that both ends of each nanotube are open.

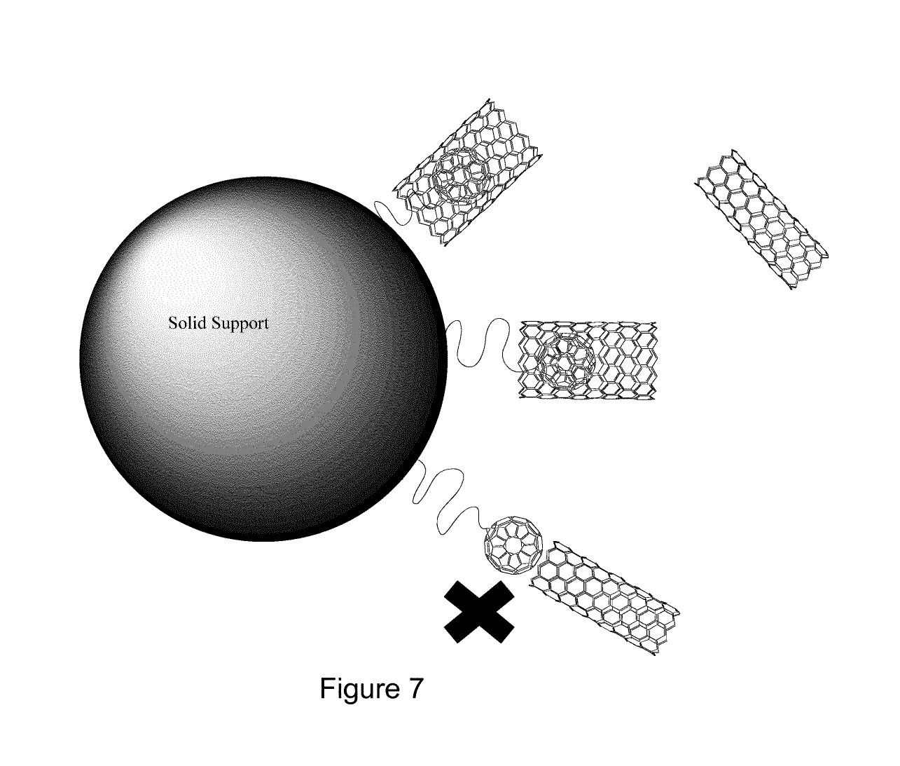

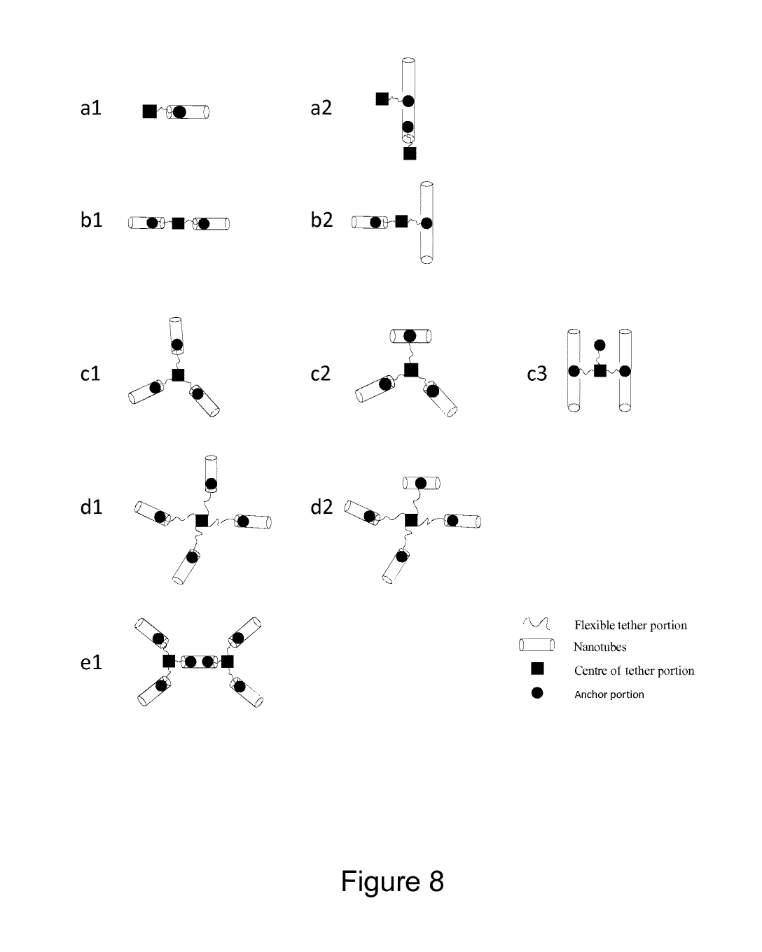

It will be appreciated by the skilled person that it is possible to etch or oxidise nanotubes such that defects or holes form in the wall of the nanotube. If these openings have a smallest inner van der Waals diameter which is the same as, or larger than, the largest outer van der Waals diameter of the anchor portion, then the anchor portion may be capable of anchoring within these defects. This effect is shown schematically in drawings a2, b2, c2, d2 and c3 in FIGS. 7 and 8.

The nanostructure of the first aspect comprises at least one anchor structure. Each anchor structure comprises a first anchor portion and a tether portion.

The first anchor portion must be capable of adsorbing to at least a part of the inner surface of the nanotube. The first anchor portion may comprise a nanoparticle. Preferably the first anchor portion comprises a fullerene.

A fullerene is a carbon-containing molecule (carbon fullerene) or a boron nitride-containing molecule (boron nitride fullerene) in the form of a hollow sphere, ellipsoid or tube. Spherical or ellipsoid fullerenes are also called buckyballs. The term “buckyball” is intended to encompass any stable spherical or ellipsoidal carbon cluster which may contain from about 20 carbon atoms up to about 300 carbon atoms. For example, the buckyball may be a C₆₀ buckyball. Other examples of buckyballs include C₇₀, C₇₂, C₇₆, C₈₀, C₈₂ and C₈₄ structures. Other suitable fullerenes include carbon nanotubes, preferably carbon SWNTs. Boron nitride fullerenes include boron nitride clusters of the general structure BₙNₙ, where n is between 12 and 60. In particularly preferred embodiments, the first anchor portion comprises buckminsterfullerene (C₆₀).

Preferably, each of the nanotubes is a SWCNT or a SWBNNT, and the first anchor portion is a carbon or boron nitride fullerene. In particularly preferred embodiments of the first aspect, each of the nanotubes is a SWCNT, and the first anchor portion is a fullerene, preferably a buckyball, even more preferably C₆₀.

The van der Waals diameter of C₆₀ is about 1 nm. Therefore, when the first anchor portion comprises C₆₀, the smallest inner van der Waals diameter of the first nanotube (preferably a SWCNT or a SWBNNT) is preferably greater than about 1 nm, for example, between about 1.05 nm and about 1.3 nm. In other words, the “normal” diameter of the first nanotube (preferably a SWCNT or a SWBNNT) is between about 1.35 nm to about 1.6 nm. When the first anchor portion comprises C₈₀, the smallest inner van der Waals diameter of the first nanotube (preferably a SWCNT or a SWBNNT) is preferably greater than about 1.1 nm, for example, between about 1.1 nm and about 1.4 nm. In other words, the “normal” diameter of the first nanotube (preferably a SWCNT or a SWBNNT) is preferably from about 1.45 nm to about 1.75 nm.

The tether portion (3) of the first anchor structure (4) is attached to the first anchor portion (2). The tether portion may also be attached either to a support, or to a second anchor portion.

The second anchor portion is as defined for the first anchor portion. For example, the second anchor portion may be a carbon or boron nitride fullerene, preferably a buckyball, more preferably C₆₀. Therefore, the preferred aspects for the first anchor potion apply equally to the second anchor portion mutatis mutandis.

When the anchor structure comprises a first and a second anchor portion, they may be the same, or they may be different. For example, the first and the second anchor portions may have a different largest outer van der Waals diameter. The skilled person will appreciate that this will allow nanotubes of different sizes to be linked together (see FIG. 2b).

The first anchor structure may comprise more than two anchor portions. In other words, the anchor structure may comprise a third, a fourth, a fifth, a sixth, or more anchor portions, collectively referred to as further anchor portions. The further anchor portions (e.g. the third, fourth, fifth, sixth, etc. anchor portions) are as defined for the first and second anchor portions. Therefore, the preferred aspects for the first and second anchor potions apply equally to the further anchor portions mutatis mutandis.

The tether portion of the anchor structure is attached to a support or to a second anchor portion. The tether potion may be any moiety which is capable of attaching the first anchor portion to a second anchor portion or to a support. For example, when the anchor portion comprises a carbon fullerene, suitable methods for attachment of the tether portion include those set out in Examples 1-4, and the methods used in Sasaki et al, Organic Letters, 2008, 10(7), 1377, and Okuda et al, Chem. Pharm. Bull., 2002, 50(7), 985, the entire contents of which are hereby incorporated by reference. When the anchor portion comprises a boron nitride fullerene, the tether portion may be attached by reaction with an amine-terminated tether portion (see, for example, Ikuno et al, Solid State Commun., 2007, 142, 643; Wu et al., j. Am. Chem. Soc., 2006, 128, 12001 and Xie, et al, Chem. Commun. (Camb), 2005, 3670, the entire contents of which are hereby incorporated by reference).

The tether portion may be rigid or flexible. By “rigid”, it is meant that the tether portion fixes the position of the first anchor portion relative to the position of the support or the second, or further, anchor portion(s).

Rigid tether portions may be capable of conducting electrons, for example, they may comprise conjugated carbon atoms. In certain embodiments, the tether portion is a rigid conductive polymer.

The tether portion of the anchor structure may be linear or branched. The tether portion may comprise one or more branches, or “arms”. For example, the tether portion may comprise three, four, five or six branches. There may be an anchor portion attached to the end of each “arm”, or branch. Alternatively, the tether portion may be grafted, or attached, to a support by one of the branches. The branches may be rigid or flexible. Preferably when the tether portion comprises branches, the branches are rigid (see FIG. 1d). When the tether portion comprises branches, the tether moiety may also comprise a metal (see FIG. 1 e or FIG. 2c).

When the tether portion comprises branches, the branches may be in a variety of different configurations or geometries. For example, if the tether portion comprises three branches, the branches may be arranged in a planar geometry, having substantially equal angles between each branch (see FIG. 1d), or the angles between the branches may be different. When the tether portion comprises four branches, the branches may, for example, be in a square planar geometry, or in a triangular-based pyramidal geometry. When the tether portion comprises six branches, the branches may, for example, be in an octahedral geometry (see FIG. 1e).

Tether portions may comprise, without limitation, flexible polymers such as polyethylene glycol (PEG), conjugated polymers or oligomers, such as polyfluorenes, polythiophenes, and poly aryl vinylenes; straight chain or branched, substituted or unsubstituted, aryl acetylenes and poly(aryl acetylenes); macrocyclic ligands as described herein, for example phthalocyanine, cyclodextrin, a cryptand a porphyrin such as an optionally substituted aryl, aryl acetylene or poly(aryl acetylene) substituted porphyrin, or a combination thereof.

The skilled person will understand that the configuration of the angles between the branches can be tailored in order to adjust the final shape and structure of the nanostructure of the invention. For example, if the nanostructure comprises an anchor structure having a linear tether (whether flexible or rigid), with two anchor portions attached to either end of the tether portion, the nanotubes in the final nanostructure may adopt a linear configuration (i.e. the nanotubes may line up end to end, with the anchor structure in between the ends). The skilled person will appreciate that if at least some of the tether portions of the nanostructures are flexible, then the final nanostructure may be non-linear, i.e. it may adopt a random coil configuration. If the anchor structure comprises a tether portion having three rigid arms with an angle of approximately 120° between each arm, and an anchor portion attached to the end of each arm, then the nanostructure may adopt a hexagonal configuration of nanotubes if the nanotubes are roughly the same length, as depicted in FIG. 3a. If the anchor structure comprises a tether portion having six rigid arms in octahedral geometry, and an anchor portion at the end of each arm, then the nanostructure may adopt a lattice-type configuration, as depicted in FIG. 3b.

The tether portion may be flexible. In other words, the tether portion may allow the first anchor portion to move so that its position is not fixed in respect of the support, or the second anchor portion. For example, the tether portion may comprise a flexible polymer.

The tether portion may comprise a sensing moiety. Examples of suitable sensing moieties include a metal atom having one or more binding sites “X”, and conjugated moieties which are capable of binding, or complexing, a small molecule.

The sensing moiety in the tether portion may be a porphyrin, or any other macrocyclic ligand which is capable of complexing a small molecule. Preferably the macrocyclic ligand is a conjugated macrocyclic ligand. For example, the macrocyclic ligand may be a phthalocyanine, cyclodextrin or a cryptand. The macrocyclic ligand may optionally be substituted.

Examples of small molecules include water, amines such as ammonia and trimethylamine, small organic compounds such as butanone, dibutyl ether, dimethyl sulfoxide, dimethyl formamide, acetonitrile, dichloromethane, nitromethanes and trimethyl phosphate, gases such as oxygen, carbon monoxide, carbon dioxide, nitrous oxides, and metal atoms such as a transition metal atom, for example, iron, nickel, palladium or zinc.

The metal atom having one or more binding sites “X” may be iron, cobalt, nickel, copper, zinc, ruthenium, titanium or platinum.

Therefore the skilled person will understand that a nanostructure which comprises a sensing moiety in the tether portion can function as a sensor for the small molecule which is capable of being bound or complexed by the sensing moiety.

When an anchor structure and a nanotube having at least one open end are brought into close proximity, self assembly of the anchor structure and nanotube takes place which results in the formation of a nanostructure according to the present invention.

When both ends of the first nanotube are open, the nanostructure of the first aspect may further comprise a second anchor structure. Therefore, in preferred embodiments of the first aspect, the nanostructure (100) comprises a first nanotube (10) having two open ends, a first anchor structure (11) and a second anchor structure (12), the first anchor structure (11) comprising a first anchor portion (13) and a tether portion (14), the second anchor structure (12) comprising a first anchor portion (15) and a tether portion (16), wherein the first anchor portion (13) of the first anchor structure (11) is configured to anchor within one open end of the first nanotube (10), the first anchor portion (15) of the second anchor structure (12) is configured to anchor within the other open end of the first nanotube (10), and wherein the tether portions (13, 16) of the first and second anchor structures are arranged to extend outside of the ends of the first nanotube (10). The first anchor portion of the second anchor structure is configured to anchor within the other open end of the first nanotube (i.e. the end not occupied by the first anchor portion of the first anchor structure), that is, the smallest inner van der Waals diameter of the first nanotube may be the same as, or greater than, the largest outer van der Waals diameter of the first anchor portion of the second anchor structure. Preferably, the smallest inner van der Waals diameter of the first nanotube is substantially similar to the largest outer van der Waals diameter of the first anchor portion of the second anchor structure. Preferably the first nanotube is a SWCNT, and the first anchor portions of the first and second anchor structures are preferably a carbon or boron nitride fullerene, for example, a buckyball, such as C₆₀. Alternatively, the first nanotube may be a boron nitride nanotube (e.g. a SWBNNT), and the first anchor portions of the first and second anchor structures may be a carbon or a boron nitride fullerene, for example C₆₀.

When the nanostructure comprises more than one anchor structure, each anchor structure may be the same or different, that is, each tether portion may be the same or different and/or each anchor portion on each anchor structure may be the same or different. Preferably, when the nanostructure of the first aspect comprises more than one anchor structure, each anchor structure is the same. In other words, the first anchor structure may be the same as, or different to, the second anchor structure.

In preferred embodiments of the first aspect, the nanostructure comprises a first nanotube with at least one open end, a second nanotube with at least one open end, and a first anchor structure, the first anchor structure comprising a tether portion, a first anchor portion and a second anchor portion, wherein the first and the second anchor portions are attached to the tether portion. The second anchor portion is configured to anchor within the open end of the second nanotube, that is, the smallest inner van der Waals diameter of the second nanotube may be the same as, or greater than, the largest outer van der Waals diameter of the second anchor portion. Preferably, the smallest inner van der Waals diameter of the second nanotube is substantially similar to the largest outer van der Waals diameter of the second anchor portion.

When the nanostructure of the first aspect comprises a first and a second nanotube, preferably both ends of the first and the second nanotubes are open.

When the nanostructure of the first aspect comprises more than one nanotube (i.e. a plurality of nanotubes) where both ends of each nanotube are open, and more than one anchor structure (i.e. a plurality of anchor structures), each anchor structure having at least two anchor portions, it will be appreciated that the nanostructure will be a continuous network of nanotubes, linked by the anchor structures. In this context, a “continuous network” is intended to encompass a nanostructure having a plurality of nanotubes anchored together by a plurality of anchor structures.

These continuous networks may form spontaneously when the nanotubes and anchor structures are present in a solution. The size of the networks may be adjusted by altering the stoichiometry of the anchor portions to the open ends of the nanotubes. Therefore, the synthesis of the nanostructures of the first aspect may involve providing a solution comprising the nanotube(s) and anchor structure(s), and allowing the nanostructure to form spontaneously. The solution may be agitated in order to assist in the self-assembly of the nanostructures. Agitation may involve stirring or sonication of the solution. Alternatively, or in addition, the solution may be heated to assist the self-assembly of the nanostructure.

The skilled person will understand that highly ordered structures can be produced by initially providing a solution of a first type of nanotube, each having two open ends (e.g. metallic SWCNTs) and anchor structures, each having at least two anchor portions and each anchor structure preferably being the same, and allowing the nanostructure to self-assemble. If the number of anchor structures is in excess of the number of nanotubes, the resulting nanostructure will be a continuous network of the first type of nanotube, wherein each of the terminal open ends of the nanotubes is occupied by the anchor structures. There will be unoccupied anchor portions within the nanostructure, given the excess of anchor portions to nanotubes.

Once the self-assembly has taken place, a second type of nanotube (e.g. semi-conducting SWCNTs), each having two open ends, may be added to the solution, optionally with further anchor structures (each of which having at least two anchor portions, and preferably being the same as the anchor structures used in the first step). The unoccupied anchor portions of the nanostructure can be used to anchor the second type of nanotube, thereby extending the continuous network of nanotubes produced by the first step.

Once the second type of nanotube has been added to the nanostructure, a third type of nanotube can be added to the nanostructure.

It will be understood that various different types of continuous networks of nanotubes can be produced. For example, a nanowire (i.e. a linear continuous network of nanotubes) having alternating types of nanotube (each having two open ends) can be produced by the sequential addition of nanotubes to a solution of anchor structures having two anchor portions. It may also be possible to achieve this type of structure by providing a plurality of anchor structures, each anchor structure having a first and a second anchor portion, wherein the first and second anchor portions have a different largest outer van der Waals diameter, and contacting the plurality of anchor structures with a plurality of first type and second type of nanotubes, both types of nanotubes having both ends open, wherein the smallest inner van der Waals diameter of the first type of nanotube is the same as, or larger than, the largest outer van der Waals diameter of the first anchor portions, and the smallest inner van der Waals diameter of the second type of nanotube is the same as, or larger than, the largest outer van der Waals diameter of the second anchor portions. The skilled person will appreciate that in order to obtain a truly alternating structure, the largest outer van der Waals diameters of the first and second anchor portions should be significantly different so that the first anchor portion does not anchor within the open end of the second type of nanotube and that the second anchor portion does not anchor within the open end of the first type of nanotube. By “significantly different” it is meant that the largest outer van der Waals diameter of the first anchor portion is larger than the largest outer van der Waals diameter of the second anchor portion by at least 0.15 nm, such as at least 0.2 nm, for example at least 0.3 nm, e.g. at least 0.4 nm. If the anchor portions are not significantly different, then the resulting nanostructure may not be a truly alternating structure (i.e. there may be some sections where a first type nanotube is anchored to another first type nanotube).

In certain embodiments of the first aspect, the nanostructure comprises a first nanotube having at least one open end and a first anchor structure comprising a first anchor portion configured to anchor within the open end of the first nanotube, the first anchor structure further comprising a tether portion arranged to allow at least a part of said tether portion to extend outside of the end of the nanotube, said tether portion being attached to a support.

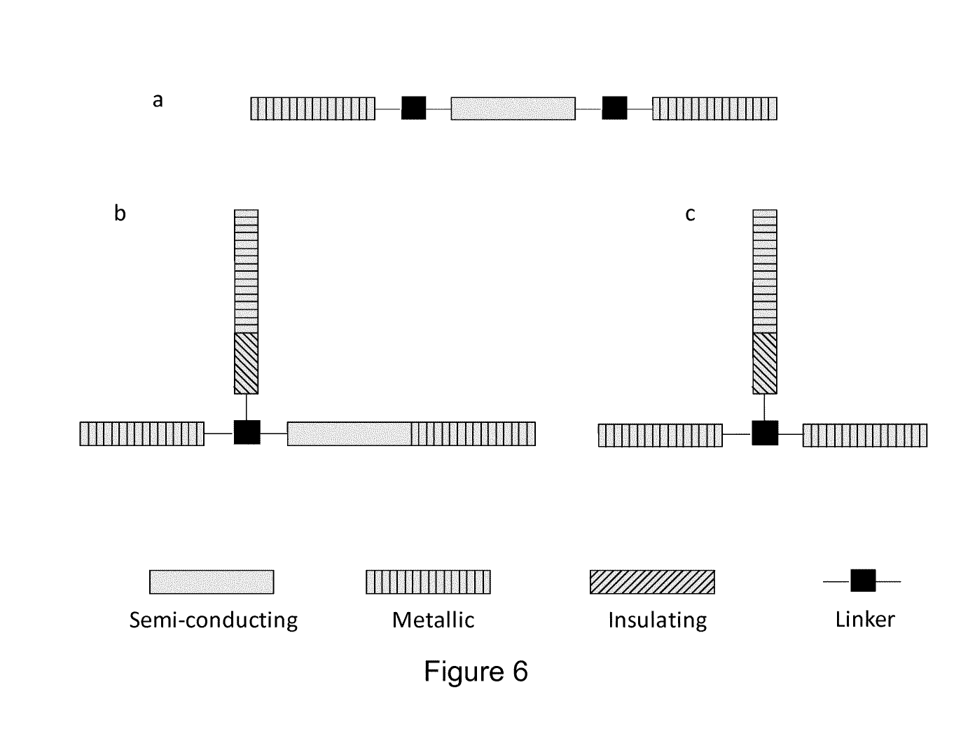

If the tether portion of the anchor structure is attached to a support, then this may allow for the separation or extraction of nanotubes from a solution comprising the nanotubes. Furthermore, the nanostructures of the present invention may allow for the selective separation of a fraction of nanotubes having a defined inner smallest van der Waals diameter from a solution comprising a plurality of nanotubes having a range of smallest inner van der Waals diameters. For example, as set out in FIG. 6, only those nanotubes having a smallest inner van der Waals diameter which is the same as, or larger than (preferably substantially similar to) the largest outer van der Waals diameter of the anchor portions will be capable of being anchored to the anchor portions, and thus the support, via the tether portions of the anchor structure. Any nanotubes having an unsuitable smallest inner van der Waals diameter will remain in the solution and can be washed from the support. The nanotubes anchored to the support can be released, for example, by cleaving the tether portion from the support, or by dissolution of the support. The nanotubes anchored to the support, once released from the support, can be used for further assembly of nanostructures.

The support may be any material which is capable of supporting a nanostructure of the invention on its surface. For example, the tether portion may be covalently bonded directly to the surface of the support. The identity of the support will vary depending on the application of the nanostructure. For example, the support may be a solid support, such as an electrode. Alternatively, the support may comprise a gel, such as a macroporous gel or a small bead structure.

Having an anchor structure attached to a support may allow for the deposition of a single nanotube on the surface of a substrate. For example, a single nanotube could be deposited between two electrodes, thereby forming a nanoelectronic device. Alternatively, if the support comprised a plurality of anchor structures, a plurality of individual nanotubes could be deposited at an interface of a composite material, such as a carbon fibre-polymer matrix. Thus, it is an aim of the invention to provide a method which allows the selective attachment of a nanotube to a support.

In a second aspect, the present invention therefore provides for a method for attaching a nanotube to a support, the method comprising the steps of:
a. Providing a solution comprising a first nanotube having at least one open end,
b. Providing a first anchor structure comprising a first anchor portion and a tether portion, wherein the first anchor portion of the first anchor structure is configured to anchor within the open end of the nanotube and the tether portion is arranged to allow at least a part of said tether portion to extend outside of the end of the nanotube,
c. Exposing the solution of step a) to the first anchor structure of step b); and
d. Attaching the tether portion to a support.

The step of attaching the tether to the support may be carried out prior to the step of exposing the solution to the anchor structure (i.e. the anchor structure may be attached to the support before the nanotube is anchored). Alternatively, the step of attaching the tether to the support may be carried out after the step of exposing the solution to the anchor structure (i.e. the nanotube may be anchored to the anchor portion of the anchor structure prior to attaching the tether portion of the anchor structure to the support).

The nanotube(s), anchor structure(s) and support are as defined for the first aspect of the invention. Therefore, all preferred embodiments of the first aspect apply equally to the second aspect, mutatis mutandis.

The skilled person will appreciate that methods for producing nanotubes often result in a product stream which comprises nanotubes having a variety lengths and diameters. It is therefore desirous to be able to select and separate a specific fraction of these nanotubes, i.e. nanotubes having a specific inner smallest van der Waals diameter. The method described above in the second aspect allows for the selective separation of a fraction of nanotubes having a specific, or selected range of, smallest inner van der Waals diameters from a plurality of nanotubes having a wide range of smallest inner van der Waals diameters.

The first anchor structure attached to the support may comprise more than one anchor portion, in other words, it may comprise a second, a third, a fourth, a fifth, a sixth or more anchor portions. When the first anchor structure comprises more than one anchor portion, these can be the same, or they can be different. For example, the each of the anchor portions may be made of a different material, or they may be made of the same material. Each of the anchor portions may have substantially the same largest outer diameter, or there may be a range of largest outer diameters. It will be appreciated that the size of the largest outer diameter of the anchor portions will affect the selection of nanotubes which are separated from the mixture.

The skilled person will also understand that there may be more than one anchor structure attached to the support, i.e. there may be a second anchor structure comprising a first anchor portion and a tether portion. In other words, the support may comprise a plurality of anchor structures. Each of the anchor structures may be the same, or they may be different.

The tether portion of the anchor structure(s) may be attached to the support using methods which are well known to the person skilled in the art. For example, the tether portion can be attached to the support by contacting a solution comprising an anchor structure having a first anchor portion and a tether portion, the tether portion comprising a reactive group that is capable of reacting with the surface of the support, thereby attaching the tether portion to the surface of the support. For example, if the support comprises silica, then the skilled person will understand that siloxane chemical reactions may be used to covalently attach the tether portion of the anchor structure(s) to the support. Varying the concentration of the anchor structure in the solution allows the density of the anchor structures attached to the surface of the support to be adjusted. For example, low concentrations will result in supports having a low density of anchor structures attached to the surface of the support. Preferably, the support comprises one or less anchor portions per about 5 nm² of the support.

If a solution of nanotubes having a range of smallest inner diameters are provided, only those nanotubes having a smallest inner diameter which is the same as, or larger than (preferably substantially similar to) the largest outer diameter of the anchor portions will be capable of being anchored to the anchor structures connected to the support. Any nanotubes which are not anchored will remain in the solution and can be washed from the support. The desired fraction of nanotubes which are anchored to the support can be removed from the support, for example, by cleaving the tether portion from the support or by exposing the support to a solvent which causes the nanotubes to detach from the anchor structures. Suitable solvents include n-methyl-2-pyrrolidone (NMP), dimethyl formamide (DMF) and dichlorobenzene (DCB).

The present invention further provides a method for thermally annealing the nanostructures of the first aspect.

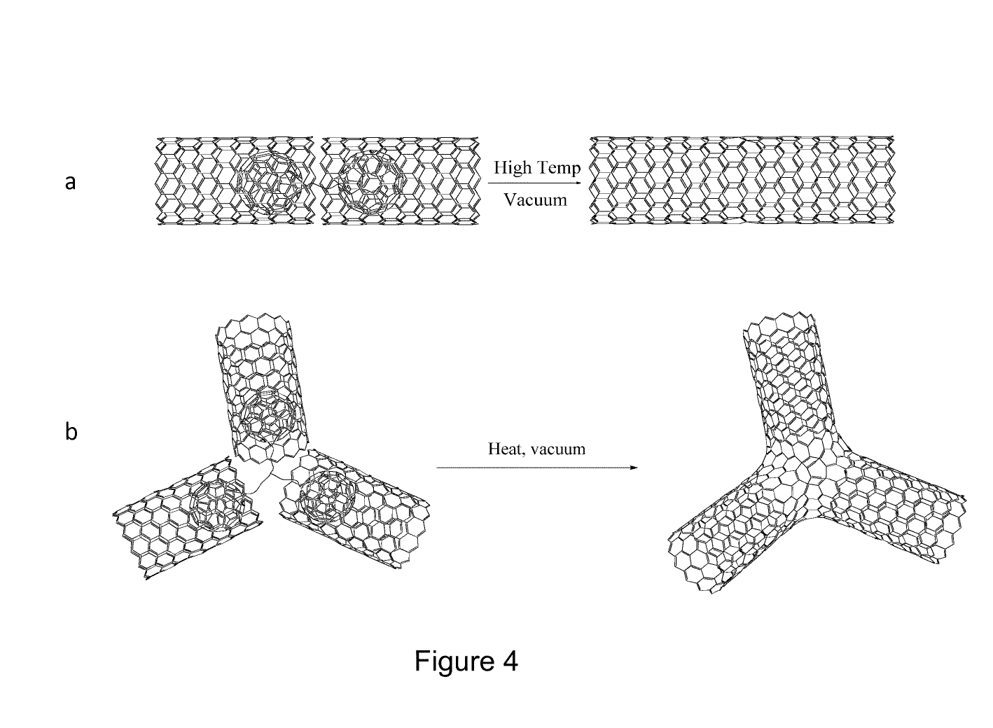

When the nanostructures of the present invention comprise an anchor structure having two or more anchor portions, and two or more nanotubes, the nanotubes which are anchored to the anchor portions are brought into close proximity. In particular, the ends of the nanotubes are arranged so that when heat and optionally a vacuum are applied, the ends of the nanotubes join in order to form a continuous nanotube structure (see FIG. 4).

Therefore, in a third aspect, the present invention provides a process for thermally annealing a nanostructure according to the first aspect, the method comprising the step of heating a nanostructure according to the first aspect, optionally under a vacuum. Preferably the step of heating is carried out at temperatures of from about 300° C. to about 1200° C., preferably from about 500° C. to about 1000° C.

The product of the method of the third aspect may result in a structure which has low electronic resistance at the nanotube junctions, improved electron transport and improved structural rigidity.

A fourth aspect of the present invention relates to a continuous nanotube structure obtained by the method according to the third aspect.

In a fifth aspect, the present invention relates to a device comprising a nanostructure according to the first aspect or a continuous nanotube structure according to the fourth aspect. In preferred embodiments, the device is an electronic device.

### DETAILED DESCRIPTION OF FIGURES

FIG. 1 shows a schematic representation of possible geometries of carbon SWNT/fullerene assemblies. In particular, FIG. 1a) shows the self assembly of an open-ended carbon SWNT (1) with an anchor structure (4) having a fullerene first anchor portion (2) attached to a flexible tether portion (3). FIG. 1b) shows the self assembly of two carbon SWNTs using an anchor structure having two fullerene anchor portions and a flexible tether portion. FIG. 1c) shows an anchor structure having a flexible tether portion and three fullerene anchor portions, allowing the anchor structure to connect three carbon SWNTs. FIG. 1d) shows an anchor structure having a rigid tether portion with three “arms”, and a fullerene anchor portion attached to the end of each arm. Each anchor portion sits within the open end a carbon SWNT. The inter-SWCNT angle is approximately 120°. FIG. 1e) shows an anchor structure having a rigid tether portion with six “arms” and an octahedral geometry. The ends of each of the arms are capped with fullerene anchor portions, each of which sits within the open end of a carbon SWNT.

FIG. 2 is a schematic representation of various carbon SWNT/fullerene assemblies. FIG. 2a) shows an anchor structure having a rigid conductive tether portion and two fullerene anchor portions at either ends of the tether. Each fullerene anchor portion sits inside of the open end of a carbon SWNT. FIG. 2b) shows an anchor structure having a flexible tether portion and two different sized fullerene anchor portions. Each of the anchor portions sits within the open end of a SWCNT. The differing sizes of the two anchor portions allow different size SWCNTs to be attached via the anchor structure. FIG. 2c) represents a nanostructure which may be useful, for example, as a sensor. The tether portion comprises a metal atom and four potential binding sites, “X”. The anchor structure has two anchor portions, which may be carbon fullerenes, each of which sit within the open end of a carbon SWNT. When one or more of the binding sites “X” are occupied, the electrical conductivity of the tether portion is different than when all binding sites “X” are unoccupied. By measuring the electrical conductivity of the nanostructure, it can be determined whether one or more or the binding sites “X” is occupied, thereby allowing the nanostructure to function as a sensor. The same principle applies when the tether portion is attached to a support.

FIG. 2d) represents a nanostructure of the invention where the tether portion of the anchor structure comprises a macrocyclic ligand which is capable of binding (i.e. complexing) a small molecule. Examples of suitable macrocyclic ligands include optionally substituted porphyrins, phthalocyanines, cyclodextrins and cryptands. It is preferred that when the macrocyclic ligand comprises a bound small molecule, the electrical conductivity of the tether portion is different to when the macrocyclic ligand does not comprise a bound small molecule. This would allow the nanostructure to act as a sensor, e.g. a chemical sensor. This effect would also be seen if the macrocyclic ligand was replaced with an antigen. FIG. 2e) represents a nanostructure where the anchor structure comprises a macrocyclic ligand and four anchor portions, each of which may be a carbon fullerene. For example, the tether portion may comprise a porphyrin. It will be appreciated that these types of structure may also be useful as a sensor.

FIG. 3 is a schematic representation which illustrates that the nanostructures of the invention can form well defined networks of nanotubes, preferably carbon SWNTs. FIG. 3a) shows a planar network of nanotubes. The anchor structures may comprise a rigid tether portion having three “arms” and an anchor portion at the end of each arm. Preferably each of the anchor sections is the same. The nanotubes are open at both ends, and the anchor portions sit within the ends of the carbon nanotubes, thereby resulting in the formation of a planar assembly. FIG. 3b) represents a 3D continuous network of nanotubes. The anchor structures may comprise a rigid tether portion having six “arms” in an octahedral geometry and an anchor portion at the end of each arm. Preferably each of the anchor portions is the same. The nanotubes are open at both ends, and the anchor portions sit within the ends of the carbon nanotubes, thereby resulting in the formation of a 3D assembly. It will be appreciated that structures represented by FIGS. 3a) and 3b) may be annealed at high temperatures, thereby resulting in in a fused continuous networks of nanotubes having electrical conductivity.

FIG. 4 is an illustration of thermal annealing of the inventive nanostructures. FIG. 4a) shows the thermal annealing of a nanostructure having two nanotubes which are linked by an anchor structure comprising two anchor portions. The ends of the nanotubes which are held, or “anchored”, in close proximity to each other by the anchor structure may be joined by thermal annealing, optionally under a vacuum. FIG. 4b) shows the thermal annealing of a nanostructure having three nanotubes which are linked by an anchor structure comprising three anchor portions. The product of the thermal annealing step has a fused ‘Y’ shape SWNT junction.

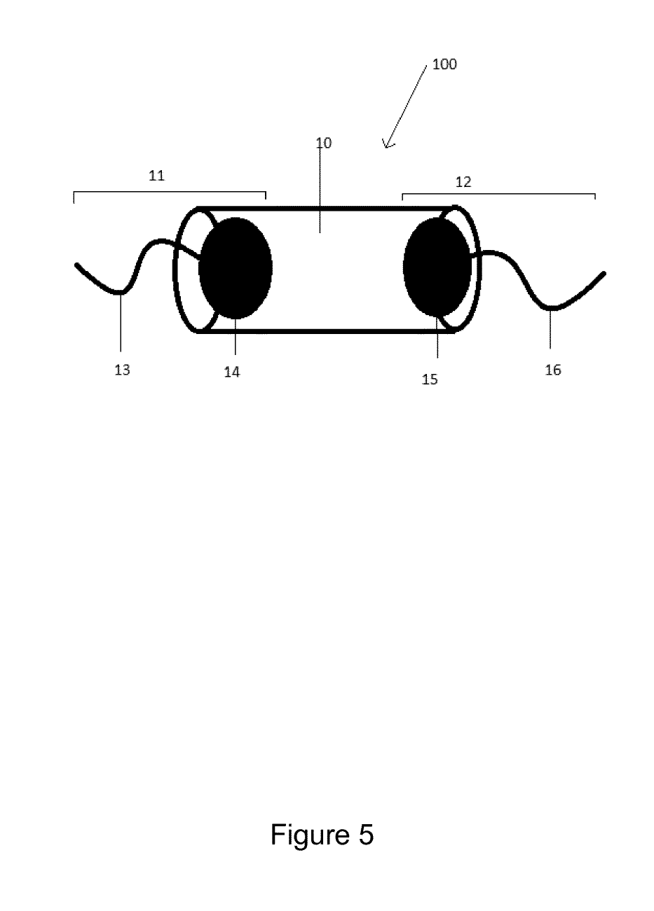

FIG. 5 is a schematic representation of a nanostructure (100) comprising a first nanotube (1), a first anchor structure (11) having a first anchor portion (13) and a tether portion (14), and a second anchor structure (12) having a first anchor portion (15) and a tether portion (16). The first anchor portion (13) of the first anchor structure (11) is configured to anchor within one open end of the first nanotube (10), the first anchor portion (15) of the second anchor structure (12) is configured to anchor within the other open end of the first nanotube (10), and the tether portions (13, 16) of the first and second anchor structures are arranged to extend outside of the ends of the first nanotube (10).

FIG. 6 is a schematic representation of various nanostructures according to the present invention. FIG. 6a) shows a metallic, or conducting, nanotube which is open at both ends, and connected at either end to two semi-conducting nanotubes by means of two anchor structures, each having two anchor portions. FIG. 6b) shows an anchor structure comprising three anchor portions. Each anchor portion may be anchored to a different nanotube, i.e. a metallic or conducting nanotube, a semi-conducting nanotube and an insulating nanotube (eg. a boron-nitride (BN) nanotube). FIG. 6c) represents a similar configuration to that of FIG. 6b) except that two of the three nanotubes are metallic or conducting nanotubes, and the third nanotube is an insulating nanotube.

FIG. 7 is an illustration of how selective diameter dependent separation of nanotubes may be achieved by using the nanostructures of the invention. Anchor structures comprising an anchor portion and a tether portion may be attached to a support via the tether portion of each anchor structure. For example, a fullerene may be grafted to a support by a flexible tether portion. Selectivity can be controlled by grafting one or more anchor structures having anchor portions (i.e. fullerenes) of different sizes to the support. The support which comprises anchor structures having anchor portions of controlled and selected sizes may be brought into contact with a mixture comprising nanotubes having a range of smallest inner diameters. Only those nanotubes having a suitable smallest inner diameter will be capable of being anchored (i.e. adsorbed) by the anchor structures attached to the support. In other words, only those nanotubes having a smallest inner diameter which is substantially similar to the largest outer diameter of the anchor portions will be anchored by the anchor portions of the anchor structures attached to the support. Any nanotubes which are not anchored remain in the mixture, i.e. they are unbound or unanchored. Thus, attaching the anchor structures to a support allows diameter selective separation of nanotubes.

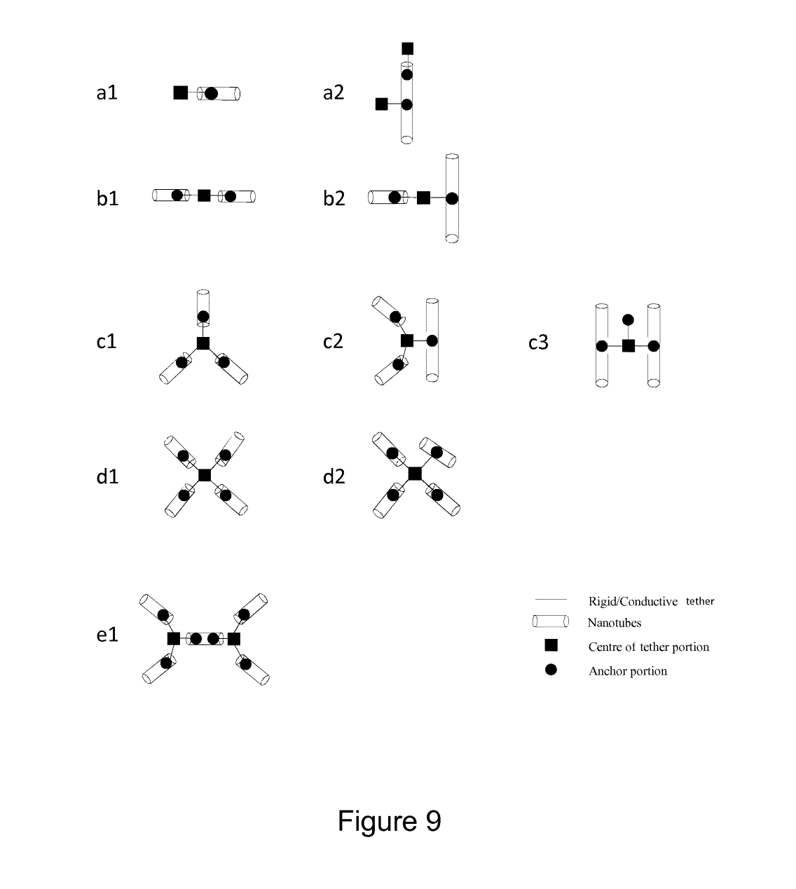

FIGS. 8 and 9 show schematic illustrations of various nanostructures according to the present invention. Figures a1-e1) show various assemblies where the desired structure is achieved by insertion of anchor portions into the open end of the nanotubes. Figures a2-d2) show various possible nanotube assemblies wherein one or more nanotubes is/are anchored to an anchor structure by the insertion of an anchor portion into a defect site along the nanotube(s). Figure c3) shows that the anchor structure may be capable of anchoring one or more nanotubes by insertion of anchor moieties into defect sites which may be located along the body of the nanotubes. In FIG. 8 the tether portions are flexible tether portions, and in FIG. 9, the tether portions are rigid tether portions.

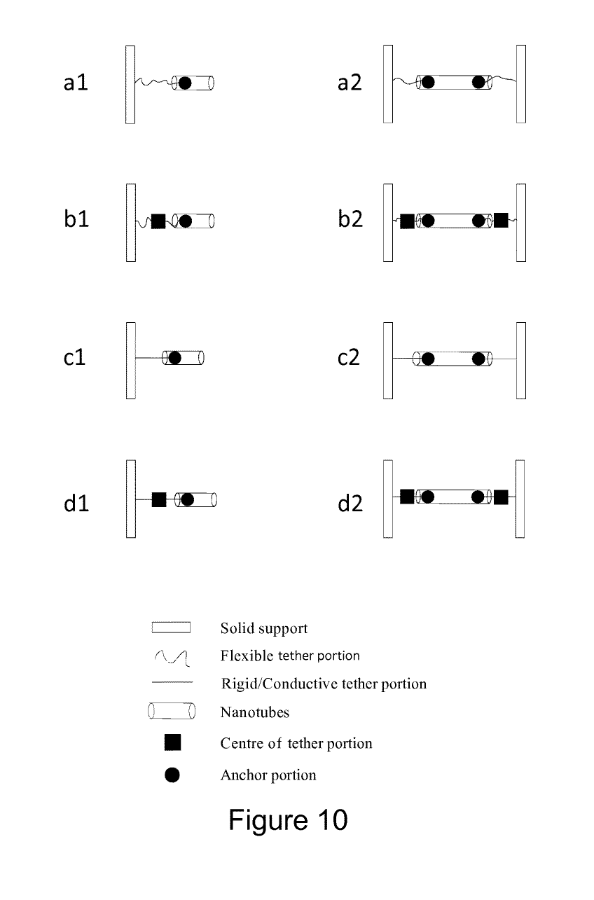

FIG. 10 is a schematic illustration of various nanostructures of the invention. Figures a1-d1) show various configurations of the nanostructures of the invention which may allow diameter selective separation of nanotubes. These nanostructures may also allow surface assembly of further structures, for example, by anchoring nanotubes in a specific configuration on a support. Figures a2-d2) show various ways in which the nanostructures of the invention may act as connectors or bridges between various supports or substrates. The skilled person will appreciate that this may allow the production of devices such as a SWNT nano-electronic device. The nanotube(s) may be anchored at two or more sites by anchor structures which in themselves are connected to one or more supports. The anchor structures may have flexible or rigid tether portions. The anchor portions may be fullerenes. The nanotubes are preferably conductive or semi-conductive.

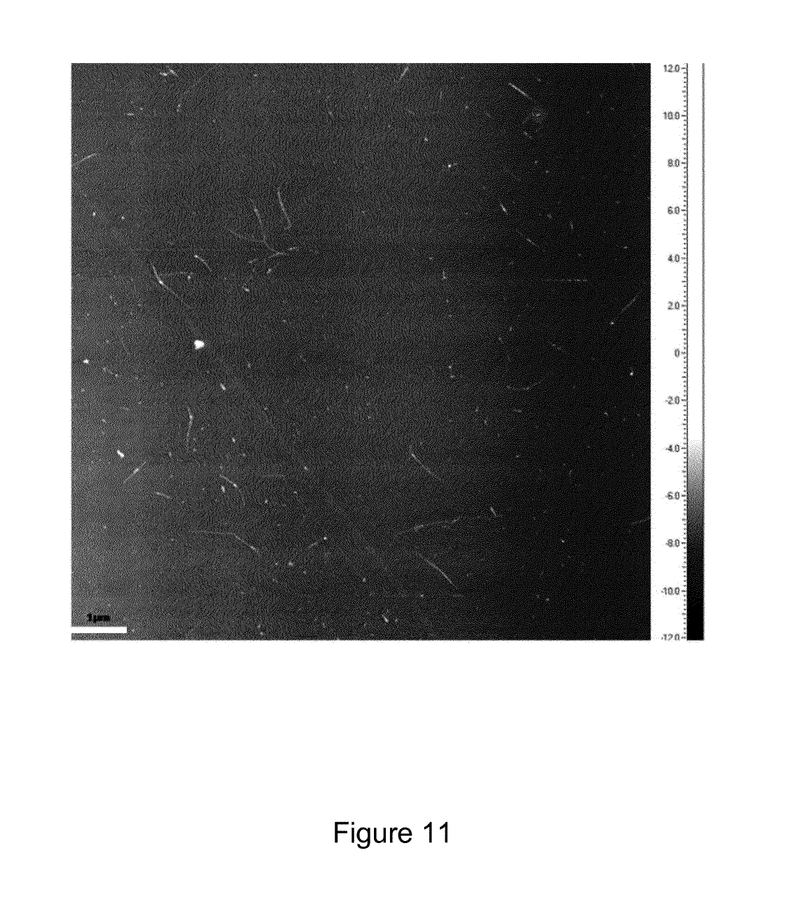

FIG. 11 is an AFM image of nanostructures comprising HiPco SWNT and anchor structures which comprising a flexible tether portion (PEG₂₀₀PCBM₂) and two fullerenes. Red arrows indicate the SWNT-SWNT junction joined by PEG₂₀₀PCBM₂ tethers.

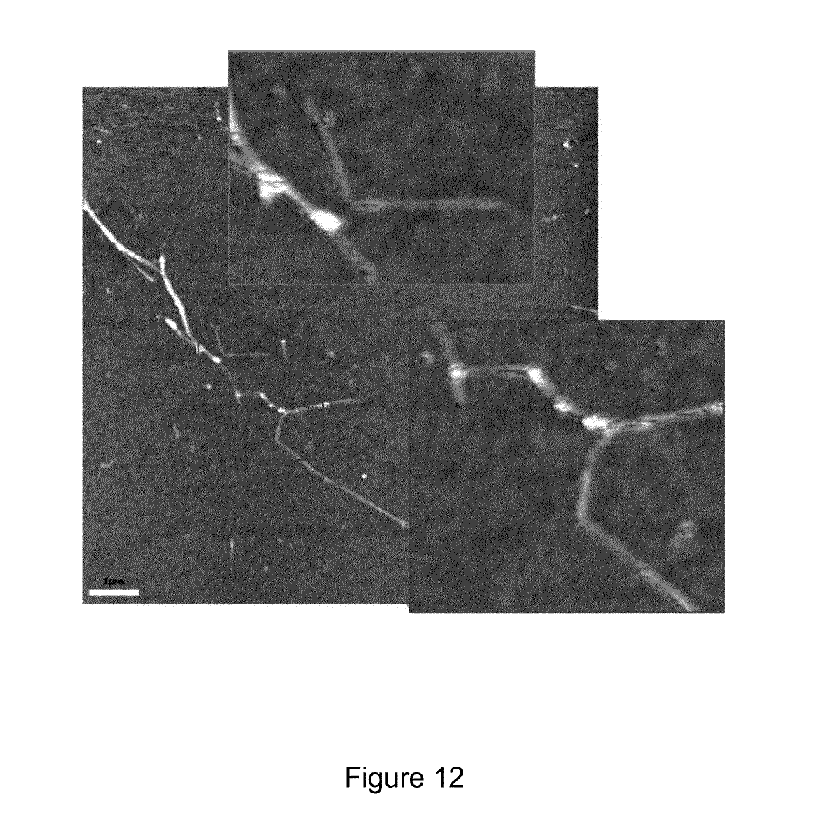

FIG. 12 is an AFM image of nanostructures comprising HiPco SWNT and anchor structures which comprising a flexible tether portion (PEG₂₀₀PCBM₂) and two fullerenes. The upper exploded view indicates a single SWNT-SWNT junction joined by PEG₂₀₀PCBM₂. The lower exploded view indicates a pseudo continuous SWNT network with PEG₂₀₀PCBM₂.

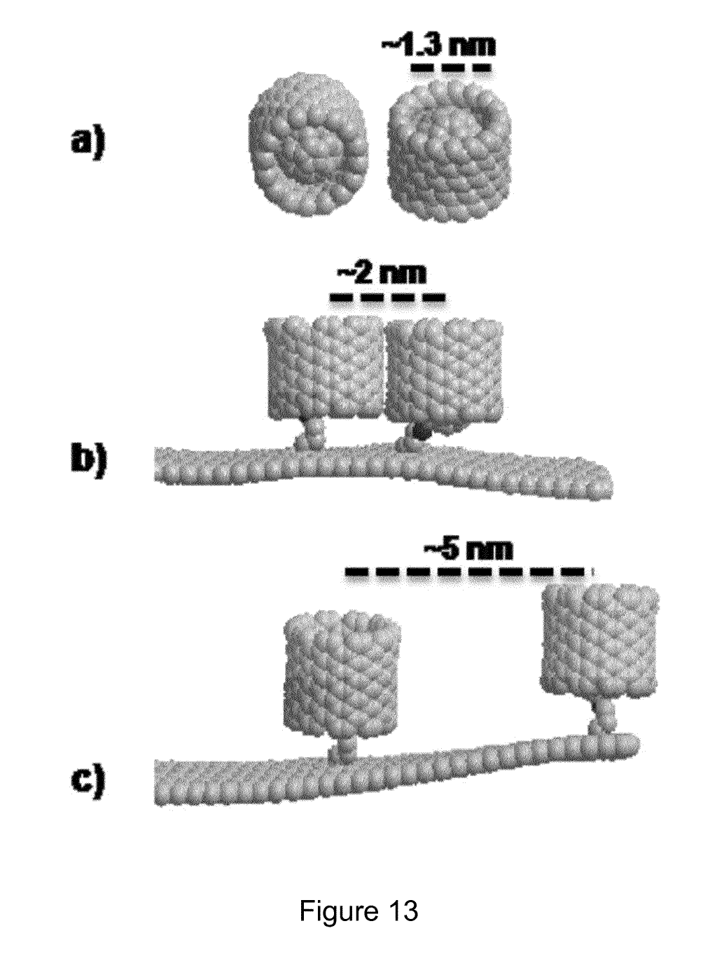

FIG. 13 shows a schematic illustration of a nanostructure of the invention attached to a support. FIG. 13a) denotes a simple insertion of C₆₀ fullerene into a 1.3 nm diameter carbon SWNT. FIG. 13b) shows carbon SWNT/C₆₀ fullerene assemblies on a surface with a minimum SWNT to SWNT distance of 2 nm which gives maximum assembly density on a surface. FIG. 13c) shows a carbon SWNT/C₆₀ fullerene surface assembly with a 5 nm SWNT to SWNT distance.

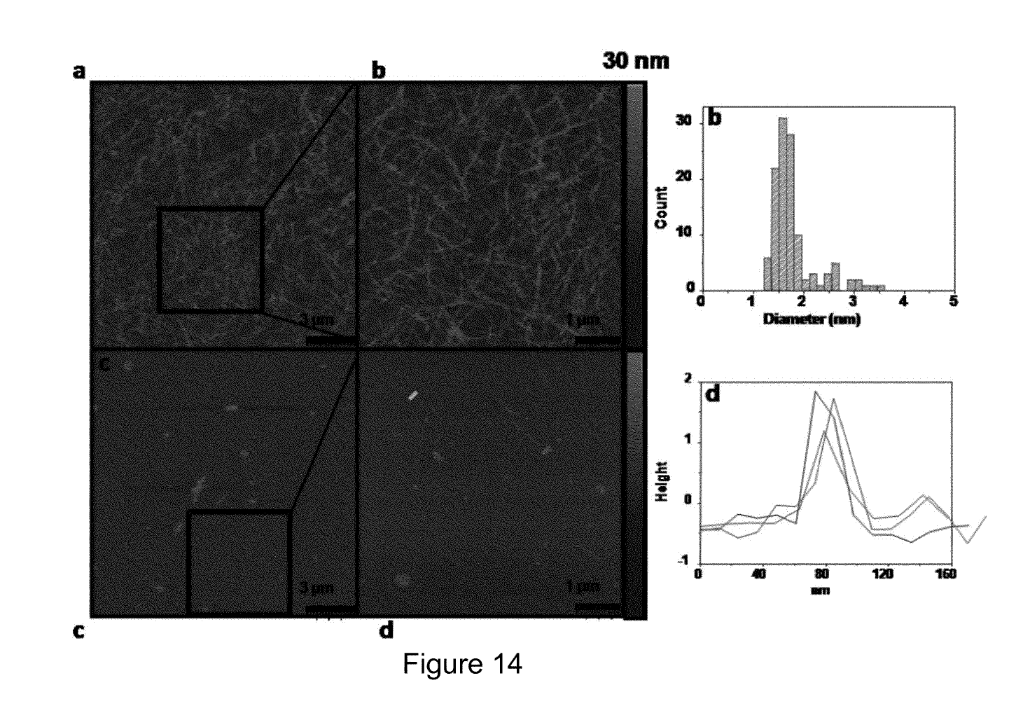

FIG. 14 shows AFM height images of (a) self assembled carbon SWNT network on C₆₀-MSW5 (b) histogram of diameter distribution of self assembled carbon SWNT network on C₆₀-MSW5 (˜110 SWNTs identified from a). FIG. 14(c) shows individualized carbon SWNTs on MSWs (Control 1: assembly experiment with MSW). FIG. 14(d) shows height analysis of three selected cross-sections in FIG. 14(c).

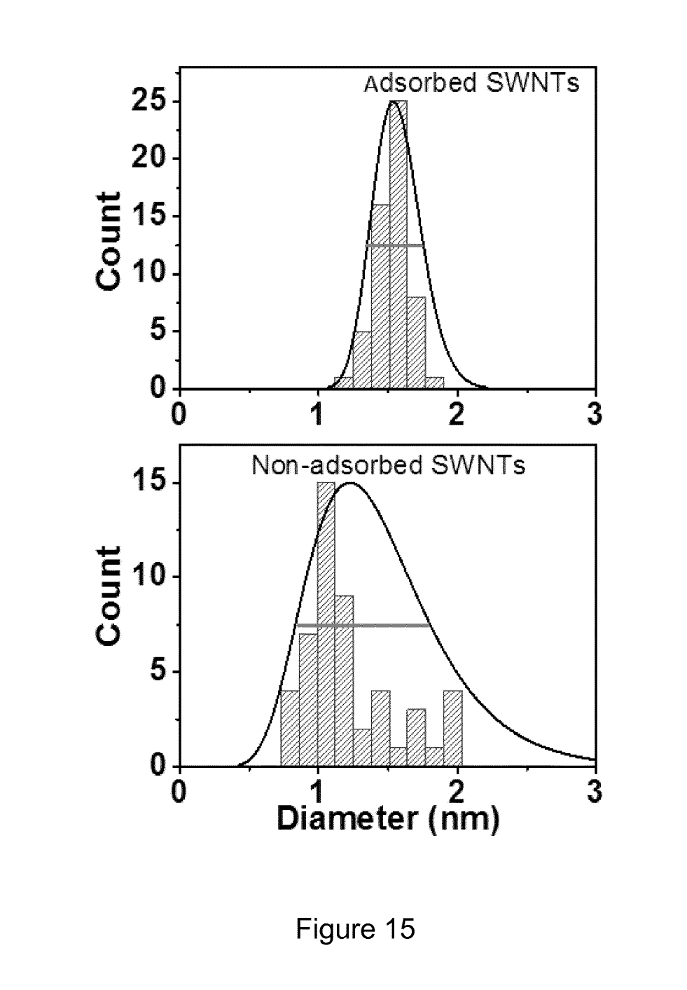

FIG. 15 shows histograms of diameter distribution of the anchored (top) and non-anchored (bottom) carbon SWNTs on the basis of AFM observations. The grey line across the curve represents f-width.

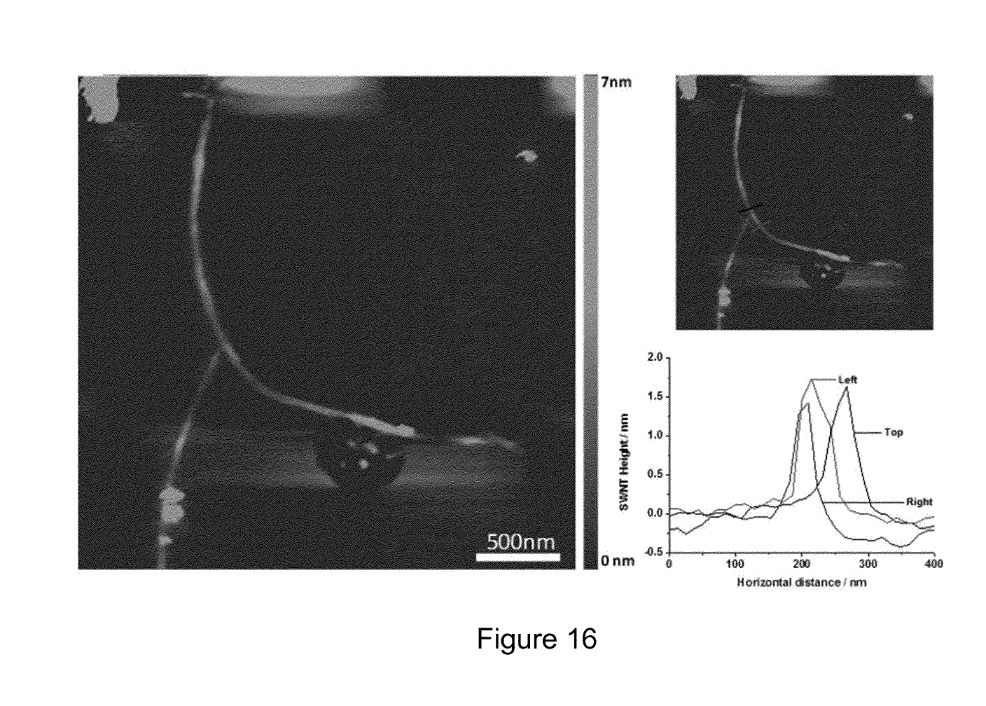

FIG. 16 shows an AFM image of a SWCNT nanostructure (Arc-discharged SWNTs with 3BPCBM) formed from an anchor structure having three arms with an anchor portion at the ends of each arm, resulting in three-way junction of nanotubes.

FIG. 17 shows a schematic representation of a nanotube encapsulating an anchor portion (e.g. a carbon or boron nitride fullerene). Figure B shows the “space-filled” version of Figure A. FIG. 17 specifically shows a (10,10) SWCNT around C₆₀.

### EXAMPLES

### Example 1

### HiPco SWNTs Dispersion Preparation

Dispersion of Single walled carbon nanotubes (SWNTs) (HiPco, Unidym) was prepared by sonicating SWNTs powder in N-methylpyrrolidone (NMP) (0.1 mg/ml) in a probe sonicator with 20% output, cooled with ice-water bath for 30 min (GEX 750, Sonics&Materials). The sonicated dispersion was then allowed to stand overnight before centrifuged at 5500 rpm for 90 min (Sigma 2-16K). 90% of the supernatant was collected. 1 ml of the supernatant was diluted with 9 ml of NMP and the diluted dispersion was sonicated at 20% output for 4 hours with 5 second interval and cool with ice-water bath. The sonicated dispersion was centrifuged at 15000 rpm for 30 min and top 50% of the supernatant was collected and diluted by a factor of 10 to yield the final dispersion for assembly.

### Synthesis of Bis-PCBM End-Capped Polyethylene Glycol [PEG-PCBM₂]

Polyethylene glycol Mₙ 200 g/mol (PEG₂₀₀) was purchased from Sigma Aldrich, UK and azotropically dried before use. [6,6]-phenyl-C₆₁-butyric acid methyl ester (PCBM) (>99.5%) was obtained from Solenne BV and vacuum dried before use. The PCBM was then reacted with PEG₂₀₀ via tranesterification with catalytic amount of dibutyltinoxide (DBTO) (>98%, Sigma Aldrich, UK) in ortho-dichlorobenzene (ODCB) at 140° C. for 5 days under nitrogen. The reaction mixture was then allowed to cool and methanol was added to the mixture and brown precipitate formed. The mixture was then centrifuged at 10000 rpm for 5 min and the supernatant was decanted off. The pellet was then washed with toluene and re-centrifuged (repeat 3 times) and the black pallet was collected and dried in vacuum to yield the bis-PCBM end-capped PEG (PEG₂₀₀-PCBM₂).

### Supramolecular Assembly of HiPco SWNTs with PEG₂₀₀-PCBM₂

1 ml of PEG₂₀₀-PCBM₂ solution (0.1 mg/ml in toluene) was added to 1 ml of the HiPco NMP dispersion. The mixture was then gently mixed with a pipette and allow to stand overnight for the self-assembly process to take place.

### Characterisation of the HiPco SWNTs Self-Assembly

Atomic Force Microscopy (AFM) is the best technique can evaluate the success of the self-assembly. Diameter measurement of the SWNTs near the junction/connection was made carefully to confirm the formation of single SWNT junctions. An example of diameter measurement is shown in FIG. 14.

### Example 2

### Arc-Discharged SWNTs Dispersion Preparation

Arc-discharged carbon SWNTs (SWNT-SO) obtained from Meijo Nano Carbon, Japan was sonicated in NMP 0.1 mg/ml for 4 hours with 60% output and cooled with ice-water bath. Ice was refilled after 2 hours of sonication. The dispersion was then centrifuged at 41000 rpm for 2 hours (Optima L-90K, Beckman Coulter and rotor: SW41 Ti). Top 80% of the supernatant was collected and diluted by a factor of 100 for assembly purposes.

### Synthesis of Tris-PCBM End-Capped Monodispersed PEG (3BPCBM)

Monodisperse 1,3,5-tris(octagoloxymethyl)benzene (BPEGₜᵣᵢₒₗ) was azotropically dried before use. PCBM was then reacted with BPEGₜᵣᵢₒₗ with catalytic amount of DBTO in anhydrous ODCB at 140° C. for 5 days under nitrogen. Solvent was then evaporated under nitrogen flow at room temperature and the dark brown solid was purified by neutralised silica gel column chromatography. Remaining unreacted PCBM was first eluted with toluene and the column was then eluted with toluene/methanol (9/1 v/v) to give tris-PCBM end-capped monodispersed PEG, 3BPCBM.

Supramolecular Assembly of Arc-Discharged SWNTs with 3BPCBM

3BPCBM was first dissolved in chloroform and diluted to 6×10⁻⁷ mol/L (concentration of number of PCBM). 50 μL of the solution was then transferred into a clean glass vial. The chloroform was evaporated with nitrogen flow and dried in vacuo. Dispersion of arc-SWNTs was then diluted with NMP until the concentration of the opened end (assuming two opened end per SWNT) was equal 3×10⁻¹¹ mol/L or 3×10⁻⁸ mol/ml. 1 ml of the dispersion was then added to the glass vial with dried 3BPCBM. The mixture was then sonicated with a bath sonicator for 5 min and allowed to stand overnight to facilitate the self assembly process.

### Characterisation of the Arc Discharged SWNTs Self-Assembly

Atomic Force Microscopy (AFM) was used to confirm the assembly; see FIG. 16.

### Example 3

### Preparation of Self Assembled SWNTs onto Fullerene Modified Silicon Wafer Surface

Synthesis of 3-azidopropyltriethoxysilane. 3-azidopropyltrimethoxysilane was synthesized following a literature procedure (Nakazawa, J. et al, J. Am. Chem. Soc., 2008. 130(44), p. 14360). 10.0 mL of 3-chloropropyltriethoxysilane (10.0 g, MW=240.09, δ=1.00, 41.7 mmol), 10 g of sodium azide (MW=65.01, 154 mmol), and 100 ml of dry DMF were heated to 90° C. under a N₂ atmosphere for 4 h. The low boiling materials were removed by distillation under reduced pressure (ca. 10 mm Hg), after which 100 ml of diethylether was added to the cooled reaction mixture and the precipitated salts were removed by filtration. Diethylether removal and distillation of the residual oil under reduced pressure (2 mm Hg, 96° C.) gave the product as a colourless liquid (6.6 g, 64%). ¹H NMR (400 MHz, CDCl₃) δ 3.83 (qd, J=7.0, 0.7, 6H, CH₃CH₂O), 3.27 (t, J=7.0, 2H, CH₂N₃), 1.86-1.60 (m, 2H, SiCH₂CH₂), 1.23 (td, J=7.0, 0.7, 9H, CH₃CH₂O), 0.80-0.59 (m, 2H, SiCH₂). ¹³O NMR (101 MHz, CDCl₃) δ 58.42, 53.80, 22.65, 18.24, 7.58. FTIR (ATR) 2975, 2927, 2887, 2095, 1391, 1166, 1101, 1074, 953, 774 cm⁻¹.

### Preparation of Methyl Only Modified Silicon Wafer (M-SW)

Surface modification was carried out following a modified literature procedure (Vandenberg, E. T., et al., Journal of Colloid and Interface Science, 1991. 147(1), p. 103-118). Silicon substrates (Agar Scientific, UK) were hydroxylated by dipping into a freshly prepared piranha solution (H₂SO₄—H₂C₂ 2:1 v/v) at 100° C. for 15 min followed by rinsing thoroughly with de-ionized water. Hydroxylated substrates were then dried under nitrogen stream. The addition of triethoxymethylsilane to silicon wafer surface was carried out at 115° C. under nitrogen atmosphere. A freshly hydroxylated silicon substrate was immersed in a solution of triethoxymethylsilane (7.01 mmol) in anhydrous DCB (20 mL) for 16 h. The substrate was removed, sonicated for 5 min in DCB (2×10 mL) then in chloroform (2×10 mL), and blown with dry nitrogen.

Preparation of propylazide-methylmodified silicon wafer (PA-M-SW5) Modified literature procedure was used (Luechinger, M., R. et al., Microporous and Mesoporous Materials, 2005. 85(1-2), p. 111-118). Silicon substrates were hydroxylated as described above and reacted with mixture of triethoxymethylsilane (6.92 mmol) and 3-azidopropyltriethoxysilane (0.08 mmol) in anhydrous DCB (20 mL) for 16 h at 115° C. Silane precursors (3-azidopropyltriethoxysilane/triethoxymethyl-silane=1/82) were mixed under N₂ atmosphere before adding to reaction medium. The substrate was removed, sonicated for 5 min in DCB (2×10 mL) then in chloroform (2×10 mL), and blown with dry nitrogen.
Preparation of C₆₀-Methyl Modified Silicon Wafer C₆₀-M-SW5

Propylazide-methyl modified silicon wafer (SW) was reacted with solution of C₆₀ (5 mg, 6.9410⁻³ mmol) in anhydrous DCB (20 mL) for 16 h at 170° C. The substrate was removed, sonicated for 5 min in DCB (2×10 mL) then in chloroform (2×10 mL), and blown with dry nitrogen.

### Self Assembly of SWNTs on Silicon Wafer

Self assembly experiments were performed by vertically immersing the modified silicon wafers into solution of open ended SWNTs (14720 ng mL⁻¹ in NMP), for 3 days. Substrates were then removed from dispersion and dried.

### Example 4

### Diameter Sorting of SWNTs by Fullerene Modified Silica Particles (SPs)

Preparation of propylazide-methyl modified silica particles (PA-M-SP5s). SPs (0.25 g) were acid treated as described above and reacted with mixture of triethoxymethylsilane (34.68 mmol) and 3-azidopropyltriethoxysilane (0.42 mmol) in anhydrous DCB (20 mL) for h at 115° C. Silane precursors (˜82 (triethoxymethylsilane)/1 (3-azidopropyltriethoxysilane)) were mixed under N₂ atmosphere before adding to reaction medium. PA-M-SP5s were purified as described above for M-SPs.

Preparation of C₆₀-Methyl Modified Silica Particles (C₆₀-M-SP5s)

Propylazide-methyl modified SPs (0.25 g) were reacted with solution of C₆₀ (200 mg, 0.27 mmol) in anhydrous DCB (50 mL) for 16 h at 170° C. C₆₀-M-SP5s were purified as described above for M-SPs.

### SWNT Diameter Sorting

Fullerene modified silica particles (0.25 g) were initially wetted by stirring in fresh NMP (1 mL) for an hour followed by the addition of 1 mL of stable nanotube dispersion (14720 ng mL⁻¹ in NMP) prepared via the method described above. Resulting mixture was mechanically stirred at room temperature for 3 days (400 rpm). Non-adsorbed SWNTs were easily separated from the mixture by centrifuging the supernatant part at 4000 rpm for 60 min, and the adsorbed SWNTs were recovered by mechanically stirring slightly coloured wet cake of C₆₀-MSP5 in fresh NMP overnight followed by centrifugation at 4000 rpm for 90 min (2×1 mL).

### Example 5

### Replacement of SWCNTs with BNNTs

It is known that boron nitride provides isostructural analogues of carbon nanostructures. Examples 1 to 4 relate to embodiments in which the nanotubes are SWCNTs. Self assembly utilising boron nitride nanotubes (BNNTs) is also possible, using an essentially similar approach. By means of example, the SWCNTs in any of examples 1 to 4 may be replaced by BNNTs, by substituting SWCNT suspensions for single walled BNNTs (SWBNNTs). Solubilisation and dispersion of SWBNNTs is possible utilising known processes, such as polymer wrapping, functionalization with amines, amino-terminated PEG and ionic surfactants. BNNTs may have open ends to allow encapsulation or ends may be opened, for example via oxidation at 950-1000° C.

It is further possible to utilise boron nitride fullerenes as an anchor portion as an alternation to carbon fullerenes. Attachment of a tether structure to a boron nitride fullerene may occur, for example, via functionalization with amine-terminated tethers.

1. A nanostructure comprising a first hollow nanotube (1) having at least one open end and a first anchor structure (4) comprising a first anchor portion (2) configured to anchor within the open end of the first nanotube (1), the first anchor structure (4) further comprising a tether portion (3) arranged to allow at least a part of said tether portion to extend outside of the end of the nanotube.

2. The nanostructure of claim 1, wherein the largest outer diameter of first anchor portion is the same as, or smaller than, the smallest inner diameter of the first nanotube.

3. The nanostructure of claim 1, wherein the first anchor structure comprises a second anchor portion.

4. The nanostructure according to claim 3, further comprising a second hollow nanotube having at least one open end and wherein the largest outer diameter of the second anchor portion is the same as, or smaller than, the smallest inner diameter of the second nanotube.

5. The nanostructure according to claim 1, wherein both ends of the first nanotube are open and the nanostructure further comprises a second anchor structure having a first anchor portion configured to anchor within the other open end of the first nanotube, the second anchor structure further comprising a tether portion arranged to allow at least a part of said tether portion to extend outside of the end of the nanotube.

6. The nanostructure according to claim 1, wherein the first and the second anchor structure are the same.

7. The nanostructure of claim 1, wherein the tether portion is attached to a support.

8. The nanostructure according to claim 1, wherein the tether portion is rigid.

9. The nanostructure according to claim 1, wherein both ends of the first nanotube and/or the second nanotube are open.

10. The nanostructure according to claim 1, wherein the tether portion is capable of conducting electrons.

11. The nanostructure according to claim 1, wherein the tether portion comprises a metal.

12. The nanostructure according to claim 1, wherein the first nanotube or the second nanotube is a carbon nanotube, a boron nitride nanotube, or a boron or nitrogen doped carbon nanotube.

13. The nanostructure according to claim 1, wherein the first nanotube and/or the second nanotube is a single walled nanotube.

14. The nanostructure according to claim 1, wherein the first anchor portion and/or the second anchor portion of the first and/or the second anchor structure is a carbon fullerene or a boron nitride fullerene.

15. The nanostructure according to claim 1, wherein the first anchor portion and/or the second anchor portion of the first and/or second anchor structure is a carbon buckminsterfullerene.

16. A method for preparing a continuous nanotube structure, comprising the step of thermally annealing a nanostructure according to claim 1.

17. The method according to claim 16, wherein the thermally annealing the nanostructure is carried out under vacuum.

18. The method according to claim 16, wherein the thermally annealing the nanostructure is carried out at a temperature of from about 300° C. to about 1200° C.

19. A continuous nanotube structure made by the method according to claim 18.

20. A method for attaching a nanotube to a support, the method comprising:
a. providing a solution comprising a first nanotube having at least one open end,
b. providing a first anchor structure comprising a first anchor portion and a tether portion, wherein the first anchor portion of the first anchor structure is configured to anchor within the open end of the nanotube and the tether portion is arranged to allow at least a part of said tether portion to extend outside of the end of the nanotube,
c. exposing the solution of step a) to the first anchor structure of step b); and
d. attaching the tether portion to a support.

21. The method according to claim 20, wherein step d) is carried out prior to step c).

22. A device comprising a nanostructure according to claim 1.

23. The device according to claim 22, which is an electronic device.

24. A device comprising a continuous nanotube structure according to claim 19.
